(19) United States
(12) Patent Application Publication
(10) Pub. No.: US 2002/0167730 A1
(43) Pub. Date: Nov. 14, 2002

(54) Wavelength selectable optical filter

(76) Inventors: Anthony Needham, Northants (GB); Crofton Brierley, Northants (GB); Richard Syms, London (GB)

Correspondence Address: FLESHNER & KIM, LLP, P.O. Box 221200, Chantilly, VA, 20153-1200, US

(21) Appl. No.: 10/135,838

(22) Filed: May 1, 2002

(30) Foreign Application Priority Data
May 2, 2001 (GB) 0110728.3

(51) Int. Cl. G02B 5/28

(52) U.S. Cl. 359/578; 359/589; 359/590

(57) ABSTRACT

A wavelength tunable optical filter 14 and a method of making the same. The optical filter 14 comprising two back-to-back Fabry-Perot optical cavities 30 & 40 comprising a fixed mirror 31 common to both cavities with parallel displaceable mirrors 32 & 42 located one on each side of the fixed mirror 31 to adjust the overall known length of the respective cavities. One optical cavity may have greater length than the other optical cavity.

### FIELD

This invention relates to wavelength selectable optical filters of the type used in communication networks.

### BACKGROUND OF THE INVENTION

In modern optical communication networks wavelength division multiplexing (WDM) technology is utilised to enable many channels carrying communication traffic to be multiplexed and passed down a single optical fibre. Each channel is allocated a specific wavelength and can travel in parallel with other channels without mutual interference. At nodes within the network, specific channels need to be isolated to extract or re-route the data carried. This may be achieved by the use of narrow band optical filters. These filters are known as drop filters.

One form of prior art filter is a fixed wavelength filter offering little flexibility to the end user. Another prior art add-drop filter is a filter which is capable of being tuned from one channel to another and incorporate optical filters which tune continuously in consequence causing interference with traffic on intermediate channels when being configured.

In the co-pending Patent Application GB 0003973.5, there is described an optical filter which makes use of two mutually coupled Fabry-Perot optical resonators for filtering multiplex input channels to pass through a selected output channel. The filter operates to allow optical radiation of specific wavelength to pass through the two coupled resonators when both are tuned to the same wavelength, in all other cases the radiation is reflected.

The present invention provides an improved tuneable optical filter and a method of manufacture of such a filter.

### STATEMENTS OF INVENTION

According to the present invention there is provided a wavelength tunable optical filter comprising two back-to-back Fabry-Perot optical cavities comprising a fixed mirror common to both cavities with parallel displaceable mirrors located one on each side of the fixed mirror to adjust the overall known length of the respective cavities.

Preferably the mirrors comprise a multilayer dielectric mirrors, preferably but not exclusively a silica-tantula stack. Preferably the movable mirrors are each held in multilayer assemblies, with each mirror being secured to one layer which is separable by actuator means from a base layer.

Said one layer comprises a web, preferably a polysilicon web, having an aperture at the centre in which the mirror locates surrounded by spaced apart concentric rings linked by radial arms to form a resilient suspension for the mirror.

Said one layer may be sub-divided into arcuate sectors, each sector being independently movable by actuator means to adjust the position of the mirror, by either displacement or tilting to provide adjustments for different wavelength selection or to maximise parallelism.

The actuator means may comprise concentric rings on the one layer which are accommodated in co-operating concentric annular slots formed in the base layer, the interdigitating rings and slots forming the actuator means which comprises an electrostatic comb drive, with said one layer forming the moveable portion of a comb drive.

The concentric annular slots in the base are divided into sectors electrically isolated from each other, permitting independent operation of different sectors of the comb drive.

Additionally, or alternatively the actuator means may comprise a plurality of thermoelectric devices, preferably bimetallic strips, which are operable to move said one layer, or sectors thereof. Where the actuator means solely comprises thermoelectric devices, the interdigitating rings and slots may be used as guide means for guiding displacement of the respective mirrors or to provide a means of capacitively sensing the displacement incurred.

The two optical cavities may have similar and adjustable lengths, or one cavity may have an overall length greatly in excess of the other for example by a factor of a least three times greater in length. The changes in length of the cavities may be sensed by capacitance sensing, preferably between electrodes on the fixed mirror assembly and electrodes on the respective movable mirror assemblies, or indirectly by sensing the change in capacitance. in the comb drive.

According to another aspect of the present invention, there is provided a wavelength tunable optical filter comprising at least one Fabry-Perot optical cavity comprising a fixed mirror common and a displaceable mirror, the movable mirror being held in a multilayer assembly, and being secured to one layer which is separable by actuator means from a base layer.

According to another aspect of the present invention there is provided a wavelength tunable optical filter comprising at least one Fabry-Perot optical cavity comprising a fixed mirror common and a displaceable mirror, the movable mirror being held in a resilient suspension which is operable base by actuator means for displacement of the mirror.

Preferably the suspension comprises a web having an aperture at the centre, in which the mirror, locates surrounded by spaced apart concentric rings linked by radial arms.

The invention further comprises an add-drop multiplexer which includes a tuneable optical filter as described above.

The invention also comprises a tuneable receiver module comprising a photon detector and integrated tuneable filter according the present invention.

Yet another aspect of the present invention provides a method of manufacture of a tuneable optical filter comprising three mirror assemblies, a fixed mirror assembly and two moveable mirror assemblies, in which the three assemblies are formed separately and then assembled together.

The fixed mirror assembly is located relative to one moveable mirror assembly and secured thereto to form a sub-assembly, and the second moveable mirror assembly is added to the sub-assembly and is located relative to the sub-assembly and then secured thereto.

The mirror assemblies are located relative to each other by alignment spacers which are inserted in location pits in the respective mirror assemblies. Preferably, both the fixed mirror assembly and second moveable mirror assembly are located relative to said one moveable mirror assembly. Any electrical connections between the assemblies are established during or after formation of the sub-assembly, and during or after the addition of the second moveable mirror assembly to the sub-assembly.

A further aspect of the invention provides a method of tuning an optical wavelength filter comprising two mutually coupled Fabry-Perot optical cavities, wherein each cavity can be tuned to a particular wavelength independently of the other cavity.

Preferably each cavity is tuneable for transmission of different optical wavelengths by minor adjustment of the lengths of the cavity, the filter transmitting particular wavelengths which are simultaneously transmissible by both filters.

The lengths of the two cavities are adjustable by displacement of mirrors located one on each side of a fixed mirror, the moveable mirrors being displaced by actuation means which is controllable to permit transmission of selected ITU wavelengths only.

The movable mirrors are displaceable by actuator means which act independently to move different areas of the respective mirror, thereby permitting cavity adjustment and optimisation of mirror parallelism.

### DESCRIPTION OF THE DRAWINGS

The invention will be described by way of example only and with reference to the accompanying drawings in which:

FIG. 1 is a schematic diagram of a tuneable drop filter according to the present invention,

FIG. 2 is a schematic drawing of a dual cavity tuneable filter as is used in the filter of FIG. 1,

FIG. 3 is a schematic section through the central fixed mirror assembly in the tuneable filter of FIG. 2,

FIG. 4 is a plan view of the central fixed mirror

FIG. 5 is a schematic section through a movable mirror assembly in the tuneable filter of FIG. 2,

FIG. 6 is a plan view of the bonded layer of the movable mirror assembly,

FIG. 7 is a plan view of the polysilicon layer of the movable mirror assembly,

FIG. 8 is a section through an assembly of the fixed central mirror and a moveable mirror,

FIG. 9 shows graphs for transmission of light radiation through the Fabry-Perot cavities of the dual cavity tuneable optical filter,

FIGS. 10-12 show stages in the manufacture of the tuneable optical filter, and

FIG. 13 shows an alternative means of assembly.

### DETAILED DESCRIPTION OF THE INVENTION

Sufficient detail of the workings of a drop filter will be given below to give an understanding of the present invention. If further details are required these may be found in GB Application 0003973.5 in the name of Marconi Communications Ltd.

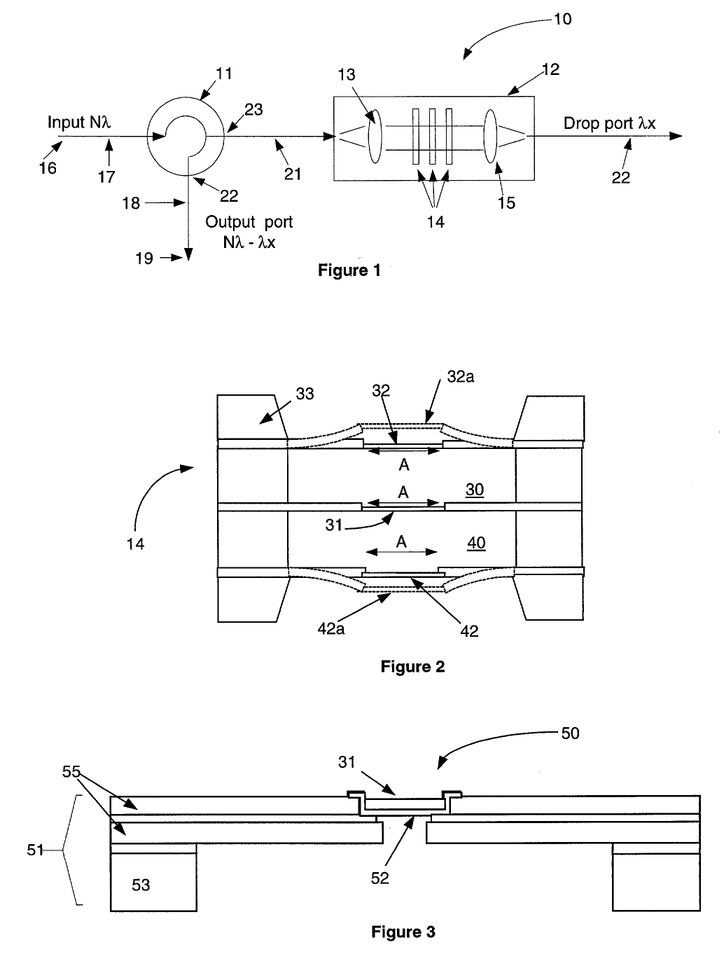

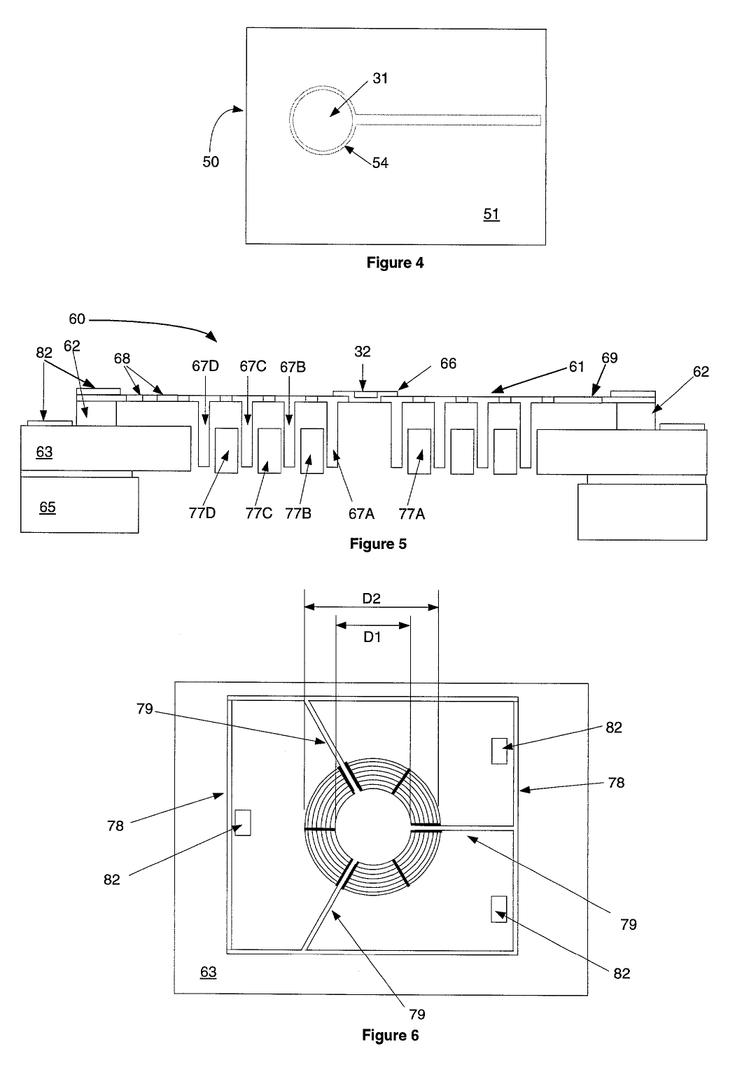

With reference to FIG. 1 there is shown a tuneable drop filter 10 which comprises a circulator 11 and a filter module 12. The filter module 11 comprises an input lens 13, a tuneable filter 14 and an output lens 15. The filter 10 includes an input port 16 connected by optical fibre 17 to an input of the circulator 11, which is connected via port 22 and optical fibre 18 to an output port 19 for the filter 10. The circulator 11 is connected via port 23 to a second optical fibre 21 to the input lens 13. The output lens 12 is connected to the drop port of the filter 10 by optical fibre 22.

The input port 16 receives a multiplex signal Nλ, typically in range 1500-1600 nm, which propagate along the fibre 17 to the circulator 11. The signal propagates within the circulator 11 to the port 23 at which its passed through fibre 21 to propagate along the fibre and through lens 13 to the tuneable filter 14. The lens 13 typically forms a collimated beam having a beam of a diameter of between 50-100 mμ which is passed into the tuneable filter 14. The filter 14 may for example be tuned to optical wavelength (channel) λX where X is any suitable wavelength. The signal components corresponding with λX propagate through the tuneable filter 14 and are received by the lens 15 through which they propagate towards the fibre 22 to the drop port of the add-drop filter 10. Signal components or channels corresponding with the other wavelengths Nλ-λX are reflected back by the tuneable filter 14 and propagate back through lens 13 and fibre 21 to the port 22 of the circulator.

These channels then propagate through the circulator 11 to its port 23 and then through the fibre 18 to the filter output port 19. A third port (not shown) may be provided to accept the reflected signals negating the need for a circulator.

The filter 10 may also be adapted for adding signal channels to a multiplex signal which correspond with the tuned channel λX.

The wavelength of the channel to be added or dropped may be altered by simply retuning the tuneable filter 14.

With reference now to FIG. 2, the tuneable filter 14 comprises two optically coupled Fabry-Perot optical cavities 30 & 40 having a central fixed dielectric mirror 31 located between a pair of independently adjustable dielectric mirrors 32 and 42. Each cavity 30 & 40 can be independently tuned for resonance with a particular channel by varying the distance between each outer mirror 32 or 42 and the central mirror 31, for example between the positions 32 & 32a, 42 & 42a.

The separation of the mirrors 31,32,42, will be dependant upon the requirements of the communications system as will the properties of the mirrors. The mirror apertures A will typically have a diameter of 150 μm, and the gap between the mirrors is preferably about 30 μm, but may be upto 100 μm for one cavity for reasons to be explained later. The mirrors should have mirror parallelism of 0.75 nm and assuming a gap between mirrors of 30 μm, inner mirror reflectance of 93.8% and outer mirror reflectance of 99.85%-99.90%.

The tuneable filter has a silicon body 33 formed using micro-mechanical systems (MEMS) technology combining deep reactive ion etching of bonded silicon-on-insulator (SOI) materials, and surface machining of polysilicon.

The mirrors 31,32, 42 are held in respective mirror assemblies as will described in detail.

Now with reference to FIGS. 3 & 4, there is shown, the fixed mirror 31 located at the centre of a fixed mirror assembly 50. The assembly 50 comprises a base 51 formed from a triple layer bonded silicon isolator (SOI) wafer wherein there is a handle 53 and two thin silicon device layers 55, each bonded with SiO2, whose layer thicknesses are chosen so that the space between adjacent mirrors is almost filled to give a robust structure and are typically each about 30-100 μm thick. In the centre of base 51 is an aperture with a silicon nitride membrane 52 supporting mirror 31, preferably a multi-layer dielectric mirror made from a silica-tantula stack. The membrane 52 is anchored to the central layer in the base 51. A sensing electrode 54 surrounds the mirror and forms part of a mirror separation control system (not shown).

With reference to FIGS. 5 to 7, each movable mirror 32 or 42 is held in a movable mirror assembly 60, only one of which will be described in detail it being understood that both assemblies are similar. The mirror 32 is located at the centre of a polysilcon membrane 61 which is spaced from an SOI wafer base 63 by a thick oxide layer 62. The lower layer 65 of the base 63 has a hollow centre.

The mirror 32, preferably comprises a multilayer dielectric mirror preferably a silica-tantula stack, is attached to the polysilicon membrane 61 by means of a silicon nitride membrane 66. The mirror is located at the centre of the concentric annular rings 67 A-D of a comb drive, the central ring 67A of which provides a drum support for the mirror 31. The rings 67 A-D are linked together by radial fingers to form the movable flexible portion 67 of an electrostatic comb drive, hereinafter the movable comb.

The polysilicon layer 61 comprises an outer region of support rings 68 linked by radial arms 69 with the movable comb 67 at the centre. A single electrical connection is connected to the structure for electrostatic actuation. The movable comb has three isolated sensor electrodes 80 which surround the mirror 32 and which are connected by radial contact arms 81 to respective contacts pads 82 at the outer ends of the arms. The sensors 80 are used to determine the gap between mirrors and parallelism at three locations.

The base 63 has a central optical aperture 77A surrounded by a series of concentric annular slots 77 B-D therein linked by radial fingers, which accommodate and co-operate with the rings on the polysilicon membrane 61 and form the fixed portion 77 of the comb drive. The central aperture 77A has a diameter D1 of about 150 μm and the fixed portion 77 of the comb drive has a diameter D2 of about 500 μm. Isolation trenches 78,79, may be formed in the base to sub-divide the comb structure to enable each sector of the comb drive to be addressed and activated separately allowing for local adjustments. This provides the ability to tilt the structure via the electrostatic drive and to maximise parallelism and other functions.

Additional to, or alternative to, the comb drive 67, is are six thermoelectric actuators 84, arranged in preferably equiangularly spaced pairs, which enable the structure to be tilted and/or lifted out of the comb drive to maximise available displacement of the mirrors. The actuators 84 are preferably bimetallic strip actuators isolated from the polysilicon layer with spaced pairs actuators linked by a low resistivity connector 85 to act in unison. As current is. passed through the arms 84 the deformation of the arms will introduce movement in linked pairs of arms located one on each side of a segment of the comb drive 67. Two actuators are employed to lift each segment and provide movement so that they can be separately adjusted by a control loop to vary cavity length and/or maximise parallelism or available displacement. Passive metal layers with tensile stress deposited on the outer one third of the radial arms can be applied to lift the polysilicon structure slightly to improve displacement.

If the thermoelectric actuators 84 are used as the primary actuation then the option exists to use the comb structure may be used as inert mechanical guides.

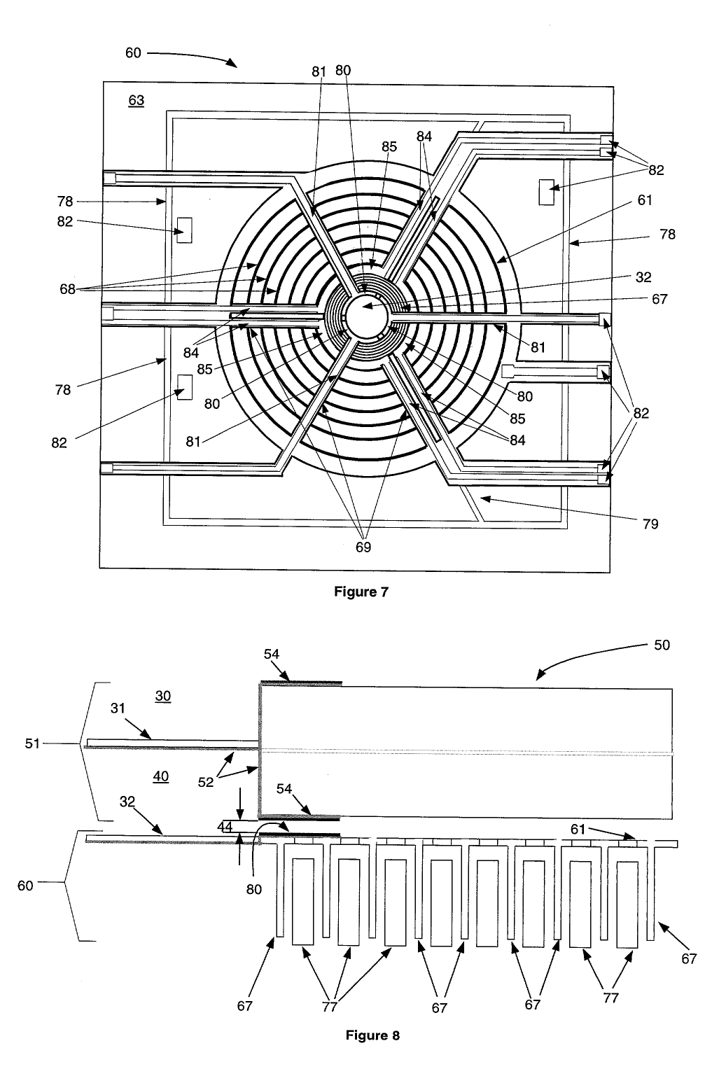

With reference now to FIG. 8, there is shown the central fixed mirror assembly 50 with one moveable mirror assembly 60, the other mirror assembly replicating this arrangement. The length of the cavity 40 between the mirrors 31 and 32 is largely defined by the thickness of the silicon layer 51, and the gap 44 between the base 51 and polysilicon membrane of the lower mirror assembly. This may for example be 25 μm and 5 μm respectively with the displacement of the movable mirror 42 being about 5 □m opening the gap upto a maximum of 10 μm.

When the two cavities are not at resonance, the filter acts as a mirror reflecting the optical signal. When the resonances of the cavities coincide light of specific wavelength is allowed to pass and all other light reflected. By slightly varying the cavity lengths and their resonances, wavelengths can be selected at will. This ability to reflect all bar the selected wavelengths without scanning and hence without interfering with data on other channels, enables the tunable filter to be used in the add-drop filter 10.

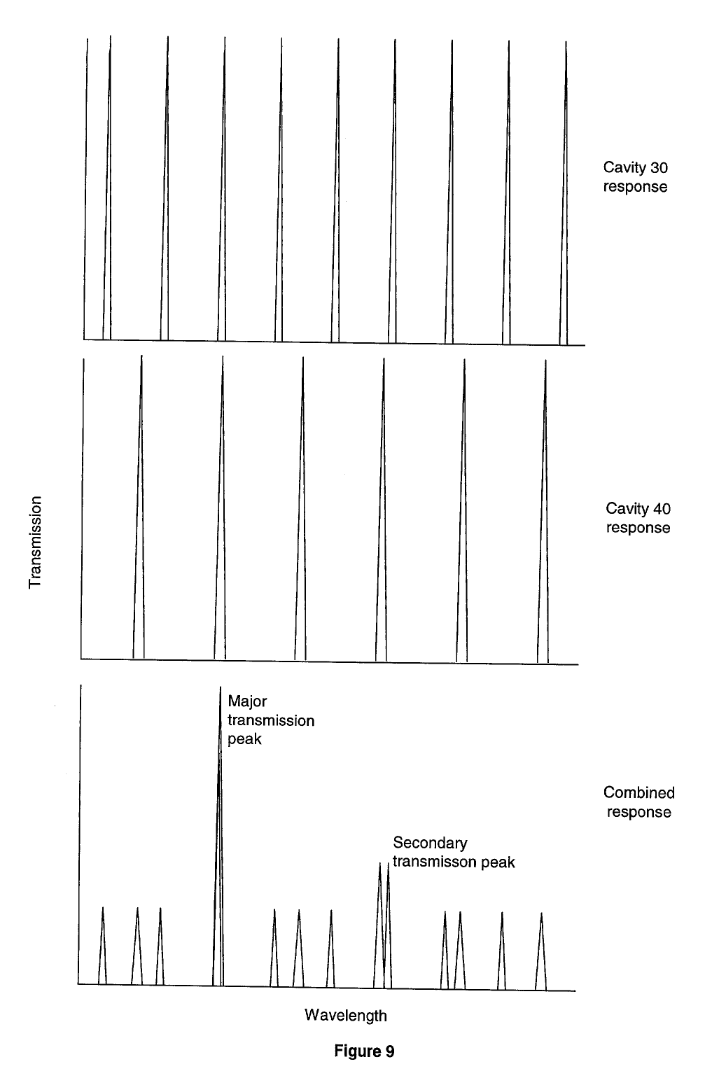

Within a single Fabry-Perot filter cavity as the length of the cavity reduces, the spacing between transmission peaks increases and the width of the transmission peaks becomes narrower. Now with reference also to FIG. 9, within a double cavity filter according to the present invention, the cavities may be of the same lengths as discussed above or of greatly dissimilar lengths e.g. one adjustable about 30 μm and the other adjustable about 90 μm each cavity 30 & 40 will present a range of transmission peaks at fixed wavelength intervals. Signal transmission will occur when one peak in one cavity 30 corresponds closely with a peak in the other cavity 40 and a major transmission peak is available. The immediately neighbouring transmission peaks are greatly reduced and secondary peaks that occur when other peaks closely coincide are higher but can be easily discarded. The width of the transmission peak can also be tailored to suit.

Selection of wavelength for transmission is achieved by pre-calibration. The cavity lengths are adjusted in a pre-programmed manner to detect all fundamental resonances for each of the ITU (International Telecommunications Union) wavelengths and a table can be configured to provide the optimum lengths for each ITU wavelength. In use the filter should be held in a constant temperature housing to prevent problems due to temperature variations.

For accurate and reliable performance the distances between the mirror 31,32 & 32, 42 and their parallelism needs to be accurately monitored and adjustments made as required. Sensing may be carried out in a number of ways including capacitive sensing between the mirrors, strain sensors embedded in the polysilicon suspension arms 69, or monitoring changes in capacitance within the comb drive. Direct measurement of the cavity length is preferred using capacitance sensing between the electrodes 80 on the moving mirror, and electrodes 54 on the fixed mirror.

As shown in FIG. 7, the electrodes 80 are segmented enabling distance to determined at a plurality of points allowing the measurement of both distances and parallelism. To avoid coupling the sensing is carried out at a high frequency far above the resonance of the surrounding structure.

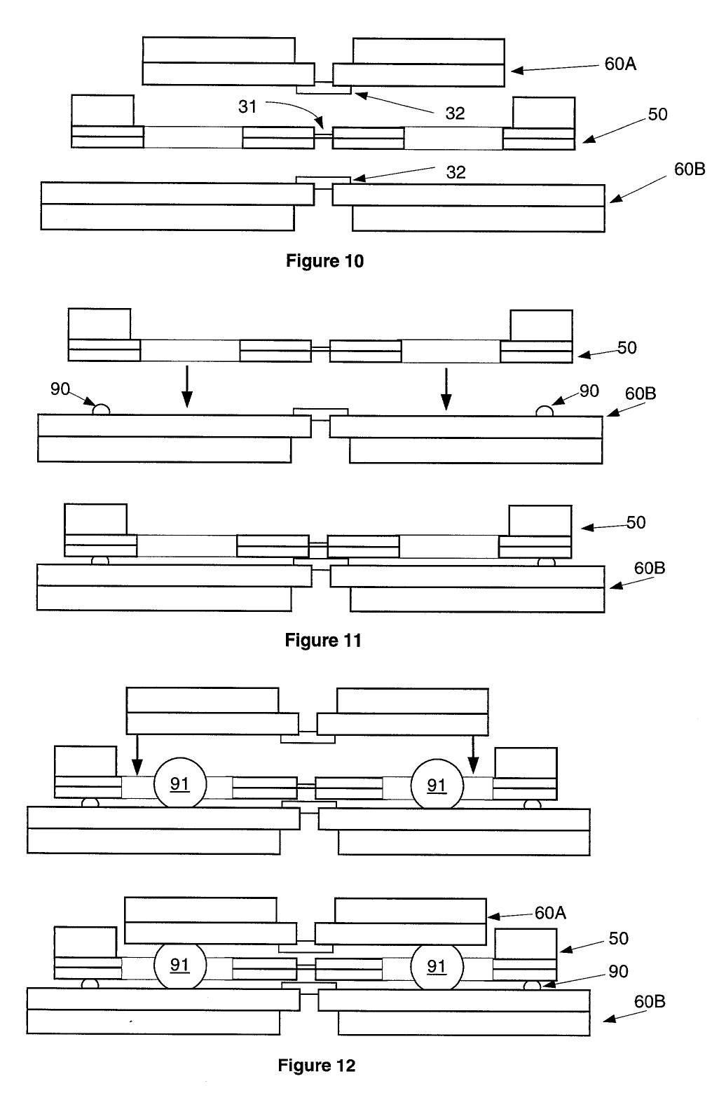

One method of assembly of the tuneable mirror is shown in FIGS. 10-12. With reference to FIG. 10, the three mirror assemblies are manufactured separately by forming layers on a substrate which define features corresponding to the mirrors and compliant support or suspension system. The fixed mirror assembly 50 for the fixed mirror 32 is sized for nesting within the movable mirror assembly 60B. The movable mirror assembly 60A is in turn sized for nesting within the fixed mirror assembly 50. The three assemblies each have location pits in areas of full wafer thickness for large alignment spacers e.g glass beads, rod or fibre, or micromachined silicon wafers or spacers.

With reference to FIG. 11, the moveable mirror assembly 60B is placed on a flat surface and alignment spacers 90 are placed in the location pits. The fixed mirror assembly 50 is lowered on top (see 11a) and located by the spacers 90, preferably three. The two assemblies are then clamped together and/or bonded by epoxy resin of controllable shrinkage to form the sub assembly shown in 11b). Electrical connections are established between the assemblies through contacts, soldering, wire bonding, the use of conductive epoxies etc.

The third mirror assembly 60A is added as is shown in FIG. 12. Spacers 91, preferably three, larger than the spacers 90, are placed in location pits in the moveable mirror assembly 60B through the apertures in the fixed mirror assembly 50. The moveable mirror assembly 60A is then lowered onto its location spacers and clamped in position. Electrical connections are then established as before.

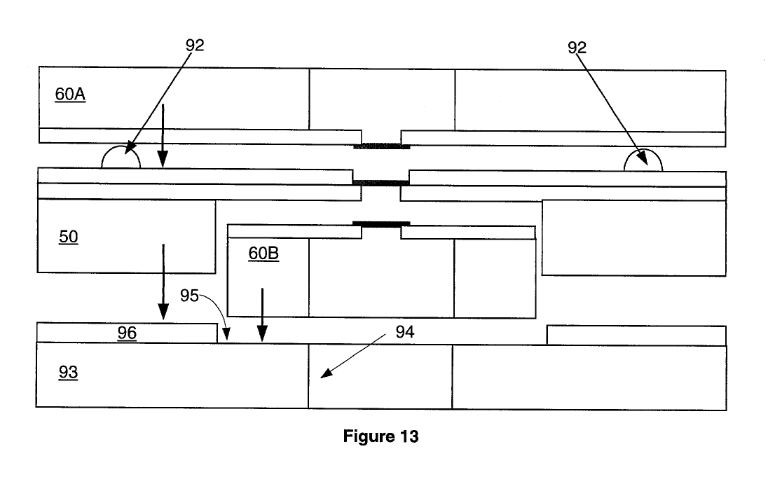

An alternative assembly method is shown in FIG. 13, in which an SOI substrate 93 acts as a base and has a central through hole 94 with a top device layer 96 having a recess 95 forming a shoulder. The hole 94 allows for the passage of light and the shoulder 95 locates the lower movable mirror assembly 60B which is bonded in the recess.

The central fixed mirror assembly 50 has gold bumps 92 on its upper surface which provide for the length of the upper cavity. The assembly 50 straddles the assembly 60B and is bonded to the device layer 96. The thickness of the device layer 96 determines the length of the lower cavity.

The upper movable mirror assembly 60A is bonded to the assembly 50 with the bumps 92 aligned with pads 82 (see FIG. 7) to provide mechanical and electrical connections. For large cavity lengths gold bumps may also be provided on upper moveable mirror assembly 60A.

1. A wavelength tunable optical filter comprising two back-to-back Fabry-Perot optical cavities comprising a fixed mirror common to both cavities with parallel displaceable mirrors located one on each side of the fixed mirror to adjust the overall known length of the respective cavities.

2. A filter as claimed in claim 1 wherein the mirrors comprise a multilayer dielectric mirror, preferably a silica-tantula stack.

3. A filter as claimed in claim 1 or claim 2 wherein the movable mirrors are each held in multilayer assemblies, with each mirror being secured to one layer which is separable from a base layer by actuator means.

4. A filter as claimed in claim 3, wherein said one layer comprises a web having an aperture at the centre, in which the mirror locates, surrounded by spaced apart concentric rings linked by radial arms, to form a resilient suspension for the respective mirror.

5. A filter as claimed in claim 3 or claim 4, wherein said one layer is subdivided into arcuate sectors each sector being independently movable by actuator means to adjust the position of the mirror.

6. A filter as claimed in claim 4 or claim 5 wherein the actuator means comprises said concentric rings on the one layer which are accommodated in co-operating concentric annular slots formed in the base layer, the interdigitating rings and slots forming the actuator means which comprises an electrostatic comb drive, with said one layer forming the moveable portion of a comb drive.

7. A filter as claimed in any one of claims 4 to 6, wherein the concentric annular slots in the base are divided into sectors electrically isolated from each other, permitting independent operation of different sectors of the comb drive.

8. A filter as claimed in any one of claims 3 to 8 comprising actuators means in the form of a plurality of thermoelectric devices which are operable to move said one layer.

9. A filter as claimed in any one of claims 1 to 8, wherein the two optical cavities have similar and adjustable lengths.

10. A filter as claimed in any one of claims 1 to 8 wherein one optical cavity has a length greatly in excess of the other by a factor of at least three times greater in length.

11. A filter as claimed in any one of claims 1 to 10 wherein the changes in length of the cavities may be sensed by capacitance sensing.

12. A filter as claimed in claim 11 wherein having capacitance sensing between electrodes on the fixed mirror assembly and electrodes on the respective movable mirror assemblies.

13. A wavelength tunable optical filter comprising at least one Fabry-Perot optical cavity comprising a fixed mirror common and a displaceable mirror, the movable mirror being held in a multilayer assembly, and being secured to one layer which is separable by actuator means from a base layer.

14. A wavelength tunable optical filter comprising at least one Fabry-Perot optical cavity comprising a fixed mirror common and a displaceable mirror, the movable mirror being held in a resilient suspension which is operable base by actuator means for displacement of the mirror.

15. An drop multiplexer including a tuneable optical filter as claimed in any one of claims 1 to 15.

16. A method of manufacture of a tuneable optical filter comprising three mirror assemblies, a fixed mirror assembly and two moveable mirror assemblies, in which the three assemblies are formed separately and then assembled together with the fixed mirror assembly located between the two moveable mirror assemblies.

17. A method as claimed in claim 16 wherein the fixed mirror assembly is located relative to one moveable mirror assembly and secured thereto to form a sub-assembly, and the second moveable mirror assembly is added to the sub-assembly also being located relative to the sub-assembly and then secured thereto.

18. A method as claimed in claim 16 and claim 17 when the mirror assemblies are located relative to each other by alignment spacers which are inserted in location pits in the respective mirror assemblies.

19. A method as claimed in claim 17 and claim 18, wherein both the fixed mirror assembly and second moveable mirror assembly are located relative to said one moveable mirror assembly.

20. A method as claimed in any one of claims 17 to 19 wherein electrical connections between the assemblies are established during or after formation of the sub-assembly, and during or after the addition of the second moveable mirror assembly to the sub-assembly.

21. A method of tuning an optical wavelength filter comprising two mutually coupled Fabry-Perot optical cavities, wherein each cavity can be tuned to a particular wavelength independently of the other cavity.

22. A method as claimed in claim 21 wherein each cavity is tuneable for transmission of different optical wavelengths by adjustment of the lengths of the cavity, the filter transmitting a particular wavelength which is simultaneously transmissible by both filters.

23. A method as claimed in claim 22 wherein the lengths of the two cavities are adjustable by displacement of mirrors located one on each side of a fixed mirror, the moveable mirrors being displaced by actuation means which is controllable to permit transmission of selected ITU wavelengths only.

24. A method as claimed in claims 22 and 23 wherein the movable mirrors are displaceable by actuator means which act independently to move different areas of the respective mirror, thereby permitting adjustment of the mirror parallelism.
